(19) United States
(12) Patent Application Publication
(10) Pub. No.: US 2006/0187926 A1
(43) Pub. Date: Aug. 24, 2006

(54) Communications session switching method and system

(75) Inventors: Naoki Imai, Fujimino-shi (JP); Manabu Isomura, Fujimino-shi (JP); Hiroki Horiuchi, Fujimino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/358,315

(22) Filed: Feb. 22, 2006

(30) Foreign Application Priority Data
Feb. 23, 2005 (JP) 2005-047012

(51) Int. Cl. H04L 12/56

(52) U.S. Cl. 370/389

(57) ABSTRACT

The invention provides a communications session switching method and system that switches a session established between communications terminals while maintaining an application in session.

A first communications terminal (1) includes a step of detecting a session switching factor and extracting configuration information on a switching target session and a step of transmitting a message including the session configuration information and session switching factor to a session management server. A session management server (4) includes a step of transmitting the message to a communications terminal in a switching target session. First and second communications terminals include a step of changing gateways and an application setting based on session configuration information and a session switching factor registered in a received message and a means of transmitting a session switching completion message to the session management server after completion of the setting change.

### BACKGROUND OF THE INVENTION

1. Field of the Invention

The present invention relates to a communications session switching method and system, and in particular, to a communications session switching method and system that switches a communications session in response to any of a change in network, a change in communications terminal, and a change in application.

2. Description of the Related Art

As a mobility support technique for a communications terminal, a network switching technique in which communications are not terminated despite a change in IP address when the communications terminal is carried around has been examined. This method allows concealing a change in network from an application but does not correspond to a more flexible mobility support to switch an application or switch a terminal in an environment where a plurality of terminals exist.

An SIP (Session Initiation Protocol) used in VoIP is a protocol to initiate a session between users. On the other hand, Non-patent Literature 1 defines a REFER method on the SIP. The REFER method is a method for executing a call transfer. As a detailed usage example thereof, one can be mentioned such that in a condition where a communications terminal A and a communications terminal B are communicating with each other, when the communications terminal A transmits a “REFER to a communications C” to the communications terminal B, the communications terminal B that has received this request shifts to a call to the communications terminal C. In this operation, a communications partner of the communications terminal B has been switched from the communications terminal A to the communications terminal C, thus execution of a terminal switching has been realized.

Non-patent Literature 1: IETFRFC3515 The Session Initiation Protocol (SIP) Refer Method

The technique using the REFER method is a terminal change on the assumption that the application is fixed, and is available in a very limited scenario. Accordingly, the technique is preferably applied to a telephone transfer function and the like.

On the other hand, in an environment where communications terminals have diversified and become ubiquitous, a communications service cannot always be executed only with a uniform application. For example, even granting that a service where users communicate with each other is realized, switching of the application itself is also demanded to suit the situation, such that according to an environment surrounding the users, VoIP is suitable in one case, and a videophone, in another case.

As a detailed example of the entire service, a scenario such that a user that had been in VoIP communications by use of a portable telephone outdoors switches the communication to a video telephone using a PC when returning to his/her office can be mentioned. In addition, at that time of switching, it can also be considered that a demand for using the portable telephone to input/output a voice despite wanting to display a videophone screen on the PC arises.

Furthermore, in communications today, communications between terminals across local networks sectioned by gateways such as NAT gateways are also frequently carried out. However, with a terminal change by the REFER method, although there is no problem on a global network or when all terminals are present on a single local network, a terminal change and the like to a communications terminal in a local network cannot be executed because of a problem of address reachability.

### SUMMARY OF THE INVENTION

It is an object of the present invention to provide a communications session switching method and system that switches a session established between communications terminals while maintaining an application executed by the session.

The present invention is characterized by including the following steps in a communications session switching method that switches a communications session established between first and second communications terminals accessible to a network where a session management server has been arranged while maintaining an application executed by the session.
(1) The first communications terminal includes: a step of detecting a session switching factor; a step of extracting configuration information on a session to be switched; a step of generating a message including the session configuration information and session switching factor; and a step of transmitting the message to the session management server,
(2) the session management server includes: a step of receiving the message; a step of specifying a switching target session based on the received message; and a step of transmitting the message to a communications terminal in the specified session, and
(3) the first and second communications terminals includes: a step of receiving a message from the session management server; a step of changing the application setting based on session configuration information and a session switching factor registered in the received message; and a step of transmitting a session switching completion message to the session management server after the setting change.

According to the present invention, the following effects can be achieved.
(1) A session management server is installed on, for example, a global network connectable from communications terminals on any network. A signaling message concerning a session switching is transmitted/received between communications terminals via the session management server. Thereby, it becomes possible to use a communications terminal connected to a private network separated by a NAT or the like as a session switching target, which allows switching a session while maintaining an application that is being executed on the session.
(2) Since transmission/reception of a signaling message concerning a session switching is carried out one-on-one or N-on-one between the communications terminal(s) and session management server, messages are not concentrated in a communications terminal link. Therefore, even when the communications terminal is a portable telephone connected to a low-speed link, it becomes possible to suppress a load on a line in comparison with that in a case of a session management on a communications terminal.
(3) Since the session management server is installed on a global network, billing management and data management by a communications carrier and a service provider are simplified.

### BRIEF DESCRIPTION OF THE DRAWINGS

FIG. 1 is a block diagram showing a configuration of the main part of a network to which a session switching system according to the present invention is applied.

FIG. 2 is a view schematically showing an example of a communications state table.

FIG. 3 is a view schematically showing an example of a session state table.

FIG. 4 is a sequence chart showing switching steps of a communications session according to a first embodiment of the present invention.

FIG. 5 is a sequence chart showing switching steps of a communications session according to a second embodiment of the present invention.

FIG. 6 is a sequence chart showing switching steps of a communications session according to a third embodiment of the present invention.

### DETAILED DESCRIPTION OF THE PREFERRED EMBODIMENT

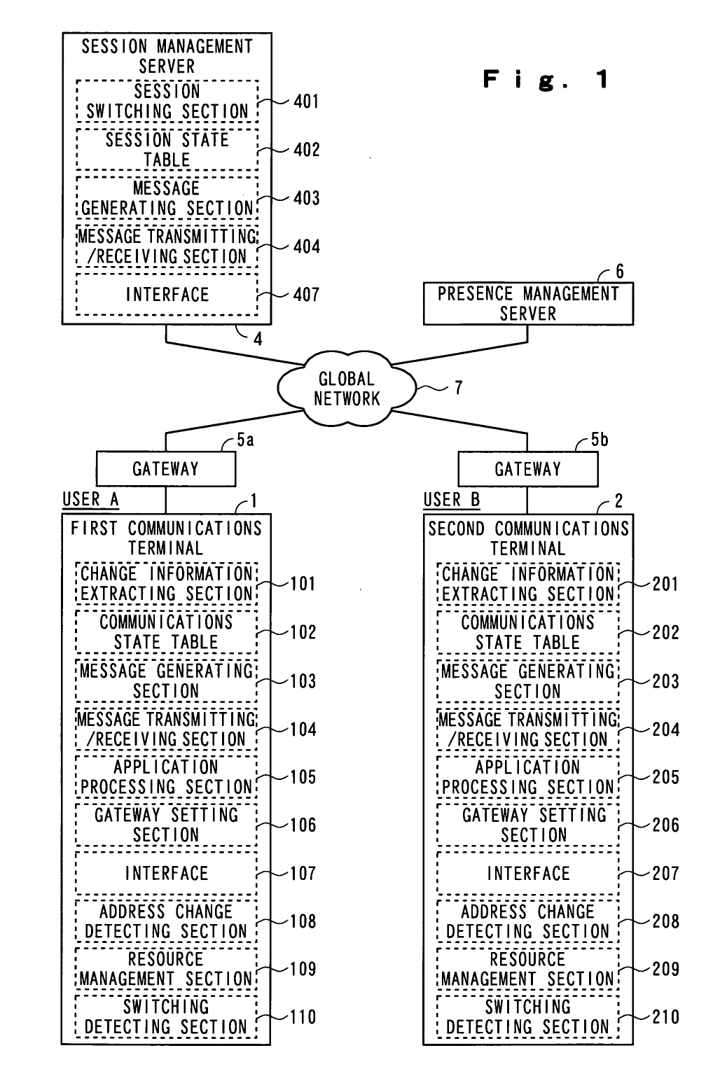

Hereinafter, preferred embodiments of the present invention will be described in detail with reference to the drawings. FIG. 1 is a block diagram showing a configuration of a network to which a session switching system according to the present invention is applied, wherein a session management server 4, first and second gateways 5 (5a and 5b), and a presence management server 6 are mutually connected via a global network 7. The first gateway 5a houses a first communications terminal 1 of a user A, and the second gateway 5b stores a second communications terminal 2 of a user B. The first and second communications terminals 1 and 2 are terminals capable of IP communications such as desktop or notebook personal computers, PDA (Personal Digital Assistants), or portable telephones, and are provided with almost identical configurations. The first and second communications terminals 1 and 2 may be household electrical appliances such as televisions or refrigerators as long as these are capable of IP communications. The global network 7 may be a local network as long as it is accessible from the first and second communications terminals 1 and 2.

Here, description will be given of a case where the first communications terminal 1 that is in communication with the second communications terminal 2 uses any of a network change, a terminal change, and an application change as a trigger to switch a communications session while maintaining a communications service that is in execution, for example.

In the present embodiment, the “network change” means that an IP address of the first communications terminal 1 is changed. The “terminal change” means that an application executing terminal is changed from the current first communications terminal 1 to another communications terminal (third communications terminal 3 to be described later) by the user A accessible to a plurality of communications terminals including the first communications terminal 1. The “application change” means that the whole or a part of an application function that is in execution in the first and second communications terminals 1 and 2 is changed to another function or another application.

In FIG. 1, a change information extracting section 101 of the first communications terminal 1 (change information extracting section 201 of the second communications terminal 2: the same applies in the following) determines a user ID of a user to which a session switching should be notified and a session ID by extracting information to be changed concerning a session that has been established between the opposite terminal and furthermore collating a communications state table 102. A message generating section 103 generates a session switching message to instruct the session management server 4 to switch a session or a session switching request message to request the session management server 4 to switch a session. In each message, a changing factor that has triggered a session switching and configuration information on a session to be a switching target are registered. The changing factor in the present embodiment is any of the “network change,” “terminal change,” and “application change.”

A message transmitting/receiving section 104 transmits/receives a message with respect to the session management server 4. An application processing section 105 executes an application start and termination, notice of information to an application, and the like in response to reception of a message transmitted from the session management server 4. A gateway setting section 106 executes an operation of the gateways 5a and 5b including a NAT setting in response to reception of a message transmitted from the session management server 4. An interface 107 connects the session management server 4 and the first communications terminal 1.

An address change detecting section 108 monitors an IP address of the interface 107 and informs, when this is changed, the change information extracting section 101 of the fact. A resource management section 109 manages a communications terminal for which the user A has accessibility and application information by notifying the presence management server 6 of application information accessible on its own terminal and acquiring an IP address of a communications terminal to which the user A is accessible and application information, which have been registered in the presence management server 6. In addition, when receiving a session switching request message to be described later, the resource management section 109 judges as to whether or not switching itself is possible.

The application information includes an application ID that uniquely specifies an application by a combination of a manufacturer of the application and an application name or the like, a function ID that indicates a function the application can provide, and information unique to the application such as a codec. A switching detecting section 110 detects a switching/change of a communications terminal or an application being selected based on information registered in the resource management section 109 and notifies the change information extracting section 101 of the fact.

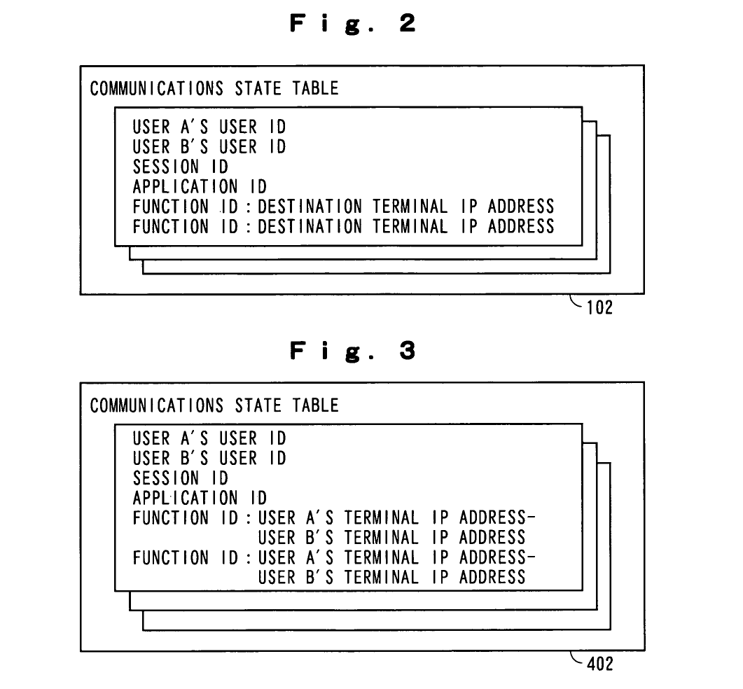

In the communications state table 102, as an example thereof schematically shown in FIG. 2, communications states have been registered concerning all sessions established between the opposite terminal. In the present embodiment, respective user IDs of the users A and B that are mutually communicating, a session ID determined at the start of communications, an application ID that specifies an application, and an IP address of the other terminal that is executing this application have been registered. When the application is provided with a plurality of separable functions, an IP address of the other terminal has been registered for each of the function IDs that uniquely specify the respective functions.

In the session management server 4, a session switching section 401 analyzes a message received from each communications terminal and collates contents of a change that has triggered a session switching, configuration information on a session to be switched, and information stored in the session state table 402 to determine contents of a notifying message and a communications terminal to which notice is given.

In the session state table 402, as an example thereof schematically shown in FIG. 3, for each of the sessions that have been established, user IDs of the respective users A and B, a session ID, and correspondence between a function ID of an application and IP addressees of communications terminals executing that function have been stored. The session state table 402 is updated every time a session is switched. A message generating section 403 generates the session switching message and a session switching request message to be described later. The message transmitting/receiving section 404 transmits/receives a message with respect to the respective communications terminals 1 and 2.

The gateway units 5a and 5b provide a NAT function concerning a packet passage and execute a gateway function setting in response to an instruction from gateway setting sections 106 and 206 of the respective communications terminals 1 and 2.

Next, a communications session switching method according to the present invention will be described for each changing target. Here, description will be given of a case where a session is switched based on (1) a change in network, (2) a change in communications terminal, and (3) a change in application as a trigger, for example.

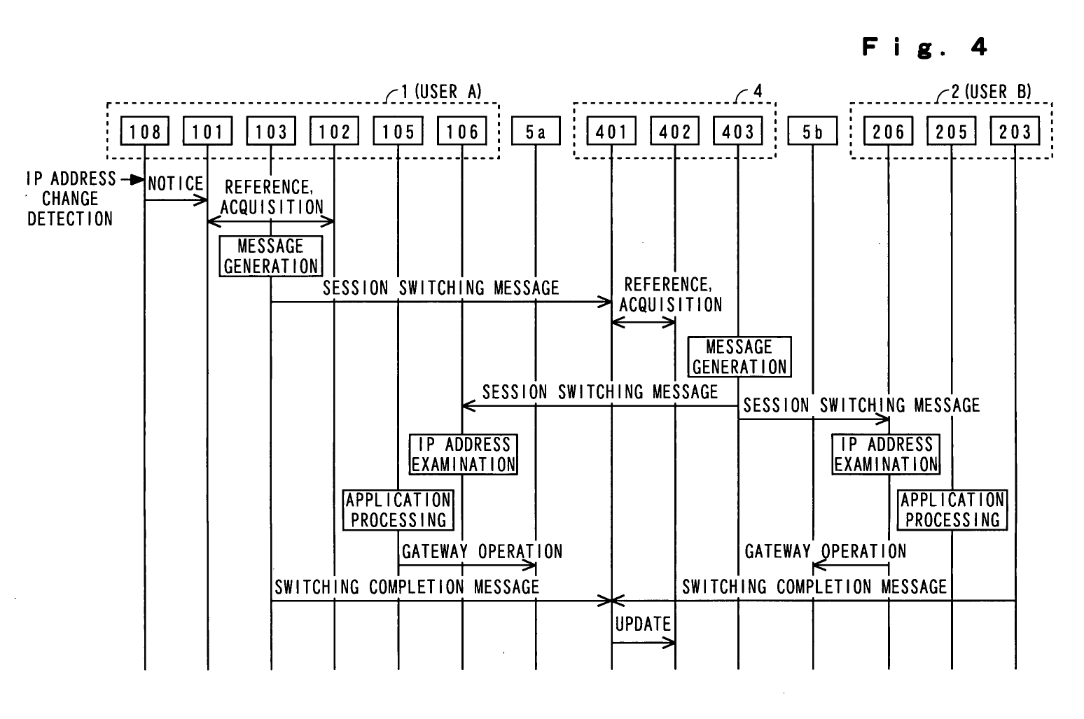

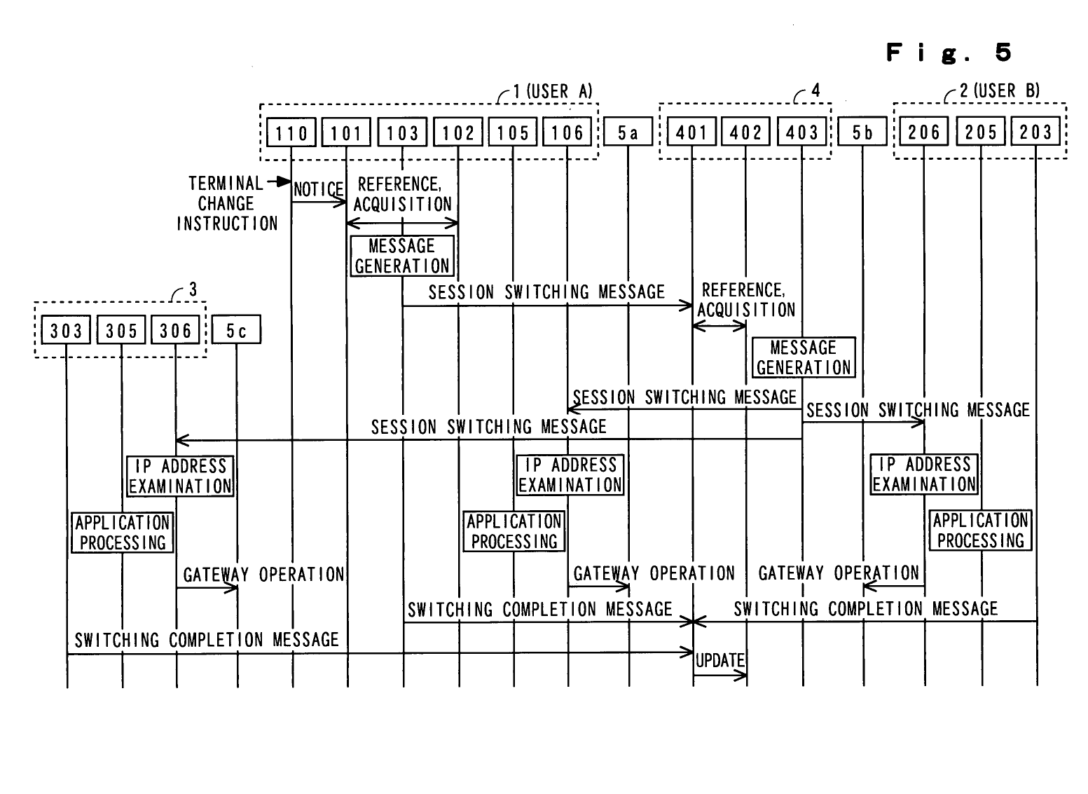

FIG. 4 is a sequence chart showing switching steps of a communications session according to a first embodiment of the present invention, wherein symbols identical to those in the foregoing denote identical or equivalent parts. In the present embodiment, a communications session is switched based on an address change resulting from a “network change” as a trigger.

In the first communications terminal 1 of the user A, when, for example, the IP address of the interface 107 is changed according to an address system of a destination network, this is detected by the address change detecting section 108 and is notified to the change information extracting section 101. The change information extracting section 101 refers to the communications state table 102 in response to the notice and acquires session configuration information including a user ID of the user B to which a network change (IP address change) is notified, a session ID inherent in a switching target session established between the users A and B, and an application ID used by the first communications terminal 1 in the session and function IDs thereof. The message generating section 103 registers a session switching factor 5 (network change in the present embodiment) and the session configuration information in a session switching message and transmits the same from the message transmitting/receiving section 104 to the session management server 4.

Upon receiving the session switching message where the session switching factor is a “network change,” the session switching section 401 of the session management server 4 collates its own session state table 402 based on the respective user IDs of the users A and B and session ID registered in this message, and extracts an IP address of the second communications terminal 2 to which a network change is notified.

In the session management server 4, furthermore, a session switching message where the session switching factor is a “network change” is prepared by the message generating section 403, and this is transmitted from the message transmitting/receiving section 404 to the first and second communications terminals 1 and 2. In this session switching message, along with the session switching factor, respective user IDs of the users A and B, a session ID, respective IP addresses of the first and second communications terminals 1 and 2 registered in the session management server 4, an application ID that requires a change in IP address and function IDs thereof, and the like have been registered.

In the first communications terminal 1, in response to reception of the session switching message, the IP address of the interface 107 is compared with the IP address of the first communications terminal 1 registered in the session switching message by the gateway setting section 106, and based on this comparison result, which communications terminal on a local network or on a global network is the communications terminal itself is judged.

If the IP address of the interface 107 is of a local network, the gateway setting section 106 sets the gateway 5a so that data from the second communications terminal 2 can be received. In contrast thereto, if the IP address of the interface 107 is an IP address on a global network, nothing is carried out. On the other hand, the application processing section 105 executes a processing concerning an IP address change and the like for an application in execution.

In the second communications terminal 2 as well, the same processing is executed in response to reception of the session switching message, and if the IP address of a communications interface 207 is an IP address on a local network, the gateway setting section 206 sets the gateway 5b so that data from the first communications terminal 1 can be received.

Upon completion of the above steps, a session switching completion message is transmitted from the first and second communications terminals 1 and 2 to the session management server 4. Upon receiving the switching completion message from all communications terminals concerning a session switching, the session management server 4 judges that a session switching has been completed and updates the session state table 402. The above operations are the same in a case where the first communications terminal 1 communicates with a plurality of communications terminals of the user B for each of the application functions.

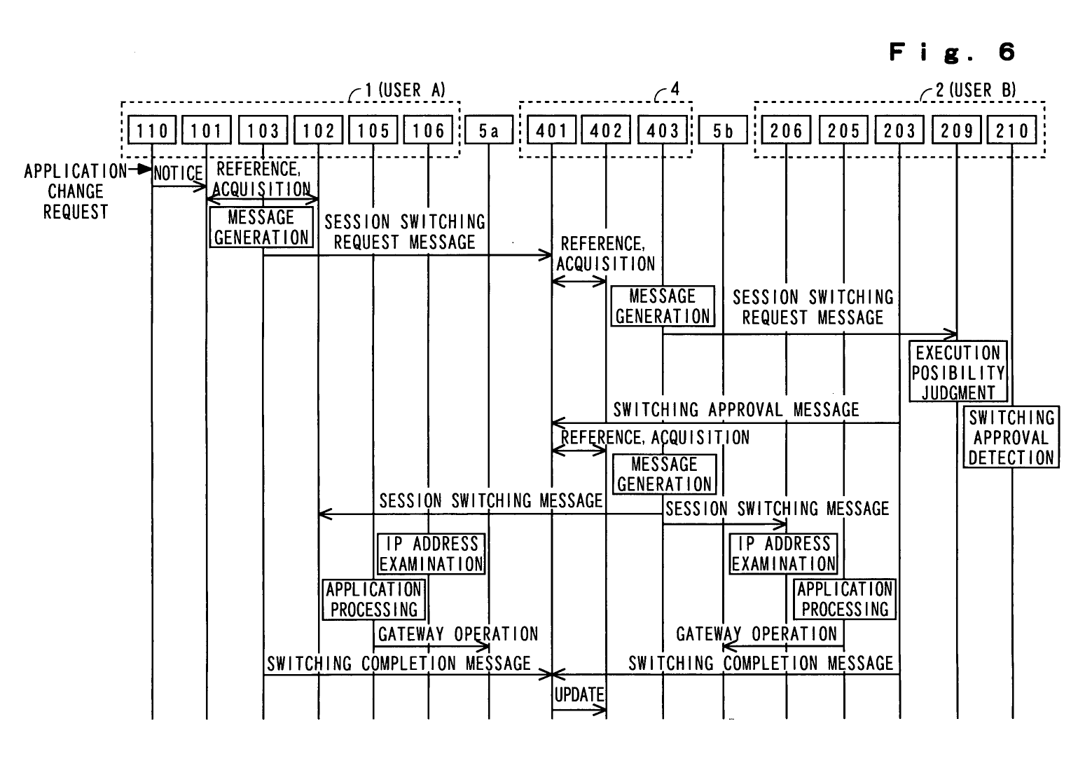

FIG. 5 is a sequence chart showing switching steps of a communications session according to a second embodiment of the present invention, wherein symbols identical to those in the foregoing denote identical or equivalent parts. In the present embodiment, a communications session is switched based on a “terminal change” as a trigger. In the present embodiment, the user A can access a third communications terminal 3 besides the first communications terminal 1.

When the user A designates an application based on management information registered in the resource managing section 109 of the first communications terminal 1 and inputs an instruction to change an executing terminal thereof from the current first communications terminal 1 to the third communications terminal 3, a terminal change instruction including function IDs of the application and an IP address of the third communications terminal 3 is detected by the switching detecting section, and this is notified to the change information extracting section 101.

The change information extracting section 101 refers to the communications state table 102 and acquires a user ID of the user B to which a terminal change is notified and a session ID. The message generating section 103 registers, along with the terminal change instruction, respective user IDs of the users A and B, function IDs of a shifting application, a session ID, and the IP address of the third communications terminal 3 to which the application is shifted in a session switching message, and transmits these from the message transmitting/receiving section 104 to the session management server 4.

Upon receiving the session switching message in which the terminal change instruction has been registered, the session switching section 401 of the session management server 4 collates its own session state table 402 based on the respective user IDs of the users A and B and session ID registered in this message, and extracts information on the second and third communications terminals 2 and 3 to which a terminal change is notified. The message generating section 403 prepares a session switching message based on the extracted information. This session switching message is transmitted from the message transmitting/receiving section 404 to the first, second, and third communications terminals 1, 2, and 3.

In the session switching message, respective user IDs of the users A and B, a session ID, respective IP addresses of the first and second communications terminals 1 and 2 registered in the session management server 4, and function IDs of an application that require a change in IP address have been registered.

Thereafter, similar to the case of a network change, in the respective communications terminals 1, 2, and 3, in response to reception of the session switching message, the IP addresses of the respective interfaces are compared with the IP addresses of the respective communications terminals registered in the session switching message by the gateway setting sections 106, 206 and 306, and based on this comparison result, which communications terminal on a local network or on a global network is the communications terminal itself is judged. If the IP addresses of the interfaces are of a local network, the gateway setting sections 106, 206, and 306 set the respective gateways 5a, 5b, and 5c so that data from the other communications terminals can be received. In contrast thereto, if the IP addresses of the interfaces are IP addresses on a global network, nothing is carried out. The respective application processing sections 105, 205, and 305 execute a processing concerning an IP address change and the like for an application in execution.

Upon completion of the above steps, a session switching completion message is transmitted from the first to third communications terminals 1, 2, and 3 to the session management server 4. Upon receiving the switching completion message from all communications terminals concerning a session switching, the session management server 4 judges that a session switching has been completed and updates the session state table 402.

FIG. 6 is a sequence chart showing switching steps of a communications session according to a third embodiment of the present invention, wherein symbols identical to those in the foregoing denote identical or equivalent parts. In the present embodiment, a communications session is switched based on an “application change” as a trigger.

Unlike the network change in the first embodiment or the terminal change in the second embodiment, since an application change causes a change in the communications state of a communications partner (user B), it becomes necessary to provide a step of gaining in advance approval to an application change from the communications partner before transmitting the session switching message. In the present embodiment, a message to be generated and transmitted according to the step is expressed as a “session switching request message” for discrimination from the “session switching message.”

When the user A inputs a request for a change in the application based on management information registered in the resource management section 109 of the first communications terminal 1, an application change request including application IDs before and after a change and function IDs thereof and the IP address of the communications terminal to activate respective functions of the application is detected by the switching detection section 110, and this is informed to the change information extracting section 101.

The change information extracting section 101 refers to the communications state table 102 and acquires a user ID of the user B to which a terminal change is notified and a session ID. The message generating section 103 stores, along with the application change request, respective user IDs of the users A and B, a session ID, an application ID after switching and function IDs thereof, and an IP address of the communications terminal to activate respective functions of the application, and transmits these from the message transmitting/receiving section 104 to the session management server 4.

Upon receiving the session switching request message, the session switching section 401 of the session management server 4 collates the session state table 402 based on the respective user IDs of the users A and B and session ID included in this message, and refers to information on the second communications terminal 2 to which the session switching request message is transmitted. Then, the message generating section 403 prepares a session switching request message and transmits the same from the message transmitting/receiving section 404 to the second communications terminal 2. This session switching request message includes respective user IDs of the users A and B, a session ID, and an application ID after switching and function IDs thereof.

In the second communications terminal 2, the session switching request message is analyzed by the resource management section 209 to judge as to whether or not the communications terminal can execute the application after switching by itself. The switching processing is terminated if execution is impossible. If switching is possible and application switching is approved by the user B, this is notified by the switching detecting section 210.

The message generating section 203 generates a switching approval message in which respective user IDs of the users A and B, a session ID, an application ID after switching and function IDs thereof, and an IP address of the communications terminal to activate respective functions of the application have been registered, and transmits the same from the message transmitting/receiving section 204 to the second communications terminal 2.

When an application change has been approved by the second communications terminal 2 in such a manner as in the above, thereafter, similar to the respective embodiments described above, the message generating section 403 prepares a session switching message and transmits the same from the message transmitting/receiving section 404 to the first and second communications terminals land 2. This session switching message includes respective user IDs of the users A and B, an application ID after switching and function IDs thereof, and an IP address of the communications terminal to activate respective functions of the application.

Although illustration is omitted, in a case where the user A that is in communication by means of the first communications terminal 1 and the user B that is in communication by means of the second terminal 2 are in communication while simultaneously using a plurality of communications terminals as well, a session can be switched by the same steps as the above.

1. A communications session switching method for switching a communications session established between first and second communications terminals accessible to a network where a session management server is arranged while maintaining an application that is executed of the session, wherein
the first communications terminal comprises:
a step of detecting a session switching factor;
a step of extracting configuration information on a session to be switched;
a step of generating a message including the session configuration information and the session switching factor; and
a step of transmitting the message to the session management server,
the session management server comprises:
a step of receiving the message;
a step of specifying a switching target session based on the received message; and
a step of transmitting the message to a communications terminal of the specified session, and
the first and second communications terminals comprise:
a step of receiving a message from the session management server;
a step of changing the application setting based on the session configuration information and the session switching factor registered in the received message; and
a step of transmitting a session switching completion message to the session management server after the setting change.

2. The communications session switching method according to claim 1, wherein
the first and second communications terminals are connected to the network via gateways, and each communications terminal changes the application setting as well as the gateway setting based on the session configuration information and the session switching factor registered in the message received from the session management server.

3. The communications session switching method according to claim 1 or 2, wherein
one of the session switching factors is a network change, and the message includes new address information assigned to the first communications terminal in a network after switching.

4. The communications session switching method according to claim 1 or 2, wherein
one of the session switching factors is a terminal change, and the message includes identification information to uniquely identify an application for which an executing terminal is shifted from the first communications terminal to a third communications terminal.

5. The communications session switching method according to claim 1 or 2, wherein
one of the session switching factors is an application change, and the message includes identification information to uniquely identify an application.

6. The communications session switching method according to claim 5, wherein
the session management server comprises a step of transmitting a message requesting an application change to the second communications terminal before transmitting a message to communications terminals in a switching target session; and
the second communications terminal comprises a step of replying as to whether or not to approve the application change to the session management server in response to the application change request message, and
the session management server transmits a message to the first and second communications terminals upon being granted the application change from the second communications terminal.

7. The communications session switching method according to claim 5, wherein
the application is provided with a plurality of separable functions, and when the application change is carried out in function units, the message includes identification information to uniquely identify application functions.

8. A communications session switching system for switching a communications session established between first and second communications terminals accessible to a network where a session management server is arranged while maintaining an application that is executed in the session, wherein
each communications terminal comprises:
a means for storing configuration information on a session established between an opposite terminal;
a means for detecting a session switching factor;
a means of extracting configuration information on a session to be a switching target;
a means for transmitting a message including the session configuration information and the session switching factor to the session management server;
a means for receiving the message from the session management server; and
a means for switching a session based on the received message.

9. The communications session switching system according to claim 8, wherein
the means for detecting a session switching factor detects a network change based on a change in an IP address assigned to the first communications terminal.

10. The communications session switching system according to claim 8 or 9, wherein
the means for detecting a session switching factor detects a terminal change whereby a terminal to execute a predetermined application is changed from the first communications terminal to a third communications terminal.

11. The communications session switching system according to claim 8 or 9, wherein
the means for detecting a session switching factor detects an application change whereby an application to provide a predetermined service is changed to another application.

12. A communications session switching system for switching a communications session established between first and second communications terminals accessible to a network where a session management server is arranged while maintaining an application that is executed in the session, wherein
the session management server comprises:
a means for storing, for each of the established sessions, identification information thereof and address information on communications terminals;
a means for receiving a message from a communications terminal;
a means for extracting address information on each communications terminal in a switching target session from the storing means based on session configuration information registered in the received message;
a means for transmitting a message including the session configuration information to each communications terminal based on the address information; and
a means for updating the storing means in response to reception of a switching completion message transmitted from each communications terminal that has completed session switching.
